(19) United States
(12) Patent Application Publication
(10) Pub. No.: US 2008/0129491 A1
(43) Pub. Date: Jun. 5, 2008

(54) Find And See Application For A Group Of Devices

(76) Inventor: Netzer Arias Ruperto, Vista, CA (US)

Correspondence Address: MINTZ, LEVIN, COHN, FERRIS, GLOVSKY AND POPEO, P.C;ATTN: PATENT INTAKE CUSTOMER NO. 64046, ONE FINANCIAL CENTER, BOSTON, MA, 02111, US

(21) Appl. No.: 11/925,672

(22) Filed: Oct. 26, 2007

Related U.S. Application Data
(60) Provisional application No. 60/854,862, filed on Oct. 26, 2006.

(51) Int. Cl. H04Q 7/20

(52) U.S. Cl. 340/539.13

(57) ABSTRACT

A system and method for locating and tracking one or more devices is disclosed. Location data and status data of the one or more devices is received at a server system through one or more communications networks. The location data includes data from the GPS or A-GPS network. A graphical representation of the location data and status data is then generated by the server system and sent to a client computer executing a location and tracking application for display in a browser window.

### CROSS REFERENCE TO RELATED APPLICATION

The present patent application claims priority under 35 U.S.C. §119 to U.S. Provisional Patent Application Ser. No. 60/854,862 filed on Oct. 26, 2006, and entitled, “Find And See Application For A Group Of Devices” the entire disclosure of which is incorporated by reference herein.

### BACKGROUND

This disclosure relates generally to computer-based mechanisms for finding and tracking one or more devices with another device, and more particularly to techniques for a finding and tracking system provided by a distributed application.

In today's mobile society, people interact through their mobile devices. Whether the mobile device is a cellular phone, a vehicle-based communication system, or laptop computer, the location and status of people can be established by their associated mobile device. For example, most mobile phones and personal digital assistants, pagers, electronic mail clients, etc., can communicate with the global positioning satellite (GPS) system that can provide geo-location data for each device. Most devices also are capable of transmitting other information, such as user ID data, power or battery life data, or other types of status data.

### SUMMARY

In general, this document discusses a system and method for tracking and monitoring one or more devices.

In one implementation, a method for finding and tracking one device from another device is disclosed. The method comprises using GPS data and status information of a primary device to determine the health and/or location of that primary device. The method further includes integrating a map or geographical coordinate information with the status information.

In one aspect, a locator and tracking system for managing one or more devices that are mobile includes a server system that receives location data and status data of the one or more devices through one or more communications networks. The system further includes a location and tracking application that is executable on a client computer in a browser window, the location and tracking application displaying a graphical representation of the location data and status data on the client computer.

In another aspect, a computer implemented method for locating and tracking one or more devices includes steps of receiving location data and status data of the one or more devices through one or more communications networks, and displaying a graphical representation of the location data and status data on a client computer executing a location and tracking application in a browser window.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a block diagram of a locator and tracking system.

FIGS. 2-10 show screenshots of a location and tracking application.

FIG. 11 is a flowchart of a location and tracking method.

Like reference symbols in the various drawings indicate like elements.

### DETAILED DESCRIPTION

This document describes a “Find and See” locator and tracking system (LTS) that can be implemented in software and an interactive website, and which allows an end user fast and easy access to the location of their vehicles, packages or loved ones. The LTS provides precise real time device tracking using digital maps downloaded to a client browser from a website. The LTS includes online device management tools to facilitate the simultaneous locating or tracking of vehicles or persons associated with a device. Users can retrieve, file or print instant history reports of all vehicle or person locations. An auto alert feature alerts a user when a vehicle or person has entered or exited a designated predetermined area (referred to as a “geo-fence”).

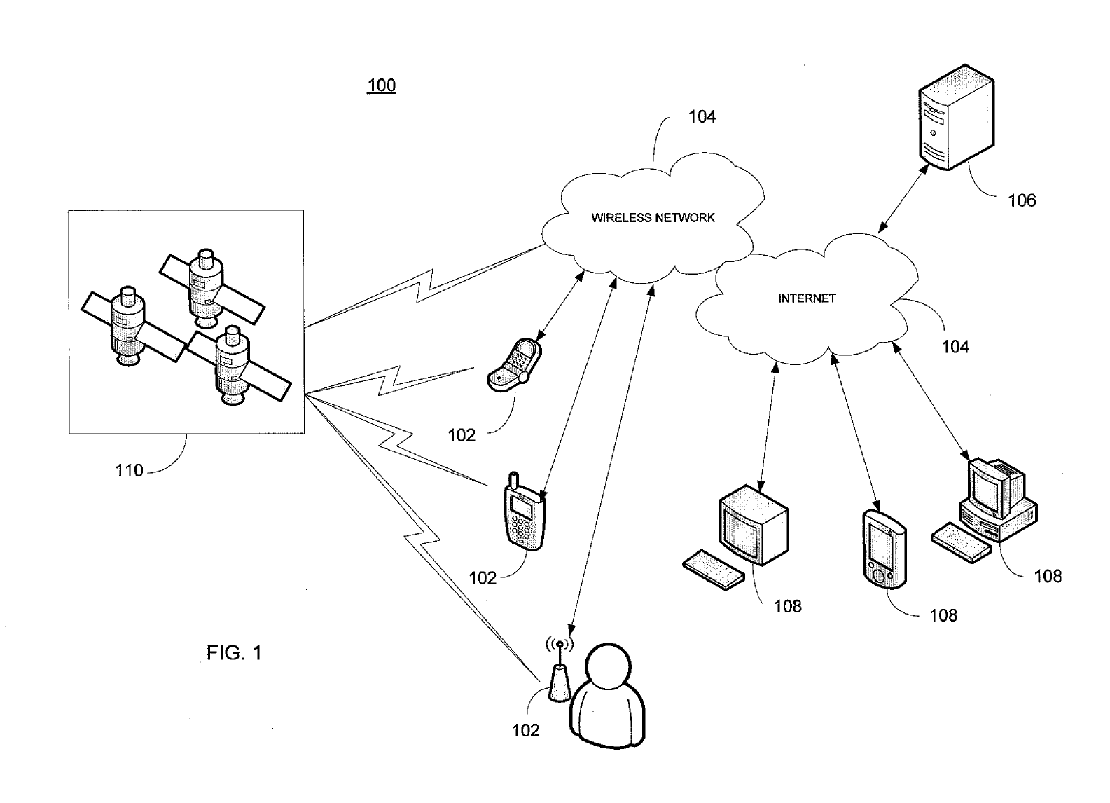

FIG. 1 is a block diagram of an LTS 100 in which a number of devices 102 provide location and status information via one or more communication networks 104 to a server system 106 that hosts a website and a location and tracking application, which is accessible by and downloadable to one or more client computers 108. The website feeds information to the location and tracking application for display to users of the client computers 108. The devices 102 can be a mobile phone, a personal digital assistant (PDA), a communication device associated with a vehicle or a person, a digital media player device, or any other mobile device that includes transmission capabilities, as well as being associated with a locator system. The location information can be established, for example, through the GPS network 110 or through Assisted GPS (A-GPS), which augments satellite-based positioning with data about a cell site a device may be associated with in a cellular network.

The one or more communication networks 104 include, without limitation, the GPS satellite network, one or more wireless communications network, and the collection of data networks that make up the Internet and associated websites that make up the World Wide Web (the Web). The server system 106 includes one or more server computers that host server software and are connected with one or more databases storing device information and user information, as well as data from which each webpage can be constructed for display in a browser at the one or more client computers 108. The client computers 108 can be a personal computer (PC), laptop computer, PDA, mobile device, or any other device that can connect to the server system 106 through the Internet and Web.

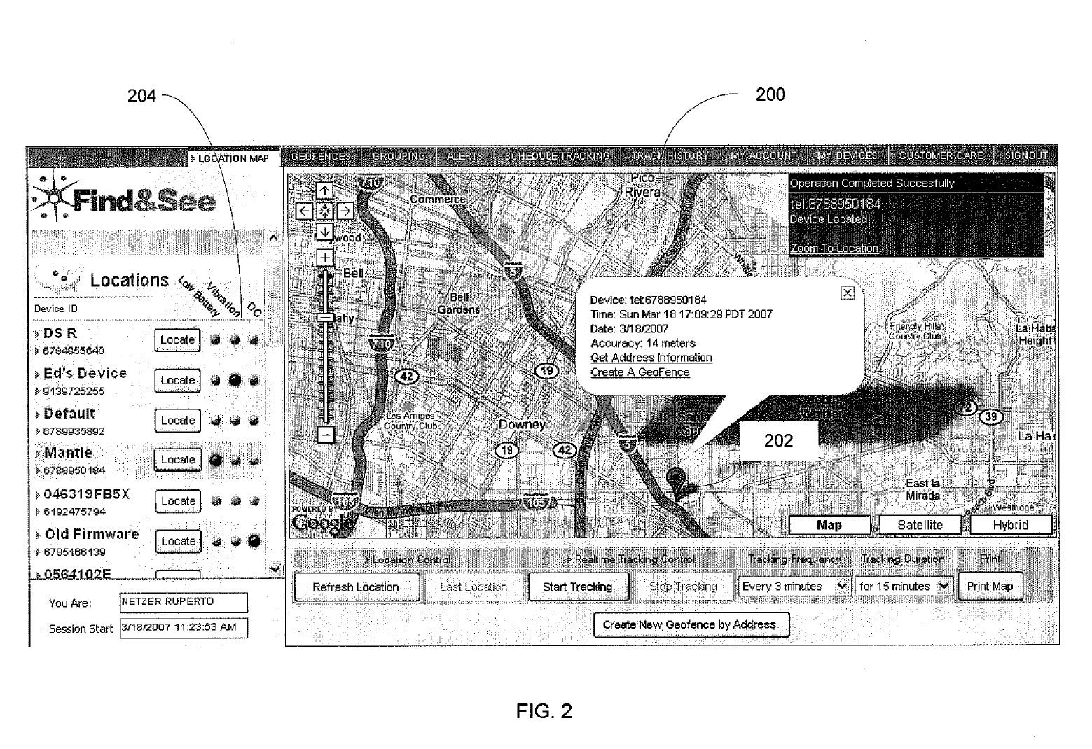

FIGS. 2-10 show exemplary screen shots of a browser-based, location and tracking application served to the client computers 108 by the server system 106. As shown in an exemplary screen shot (FIG. 2) of a browser-based, location and tracking application, the LTS 100 displays a map 200 showing a location 202 of one or more devices 102. In a preferred implementation, for each selected device 102, the LTS 100 displays at least the location, which can be stored and displayed as an address or as a custom label, and a status 204 of the device 102. The status can include metrics such as speed or velocity, battery life, signal coverage, temperature, direction, and altitude. Other metrics may also form the status.

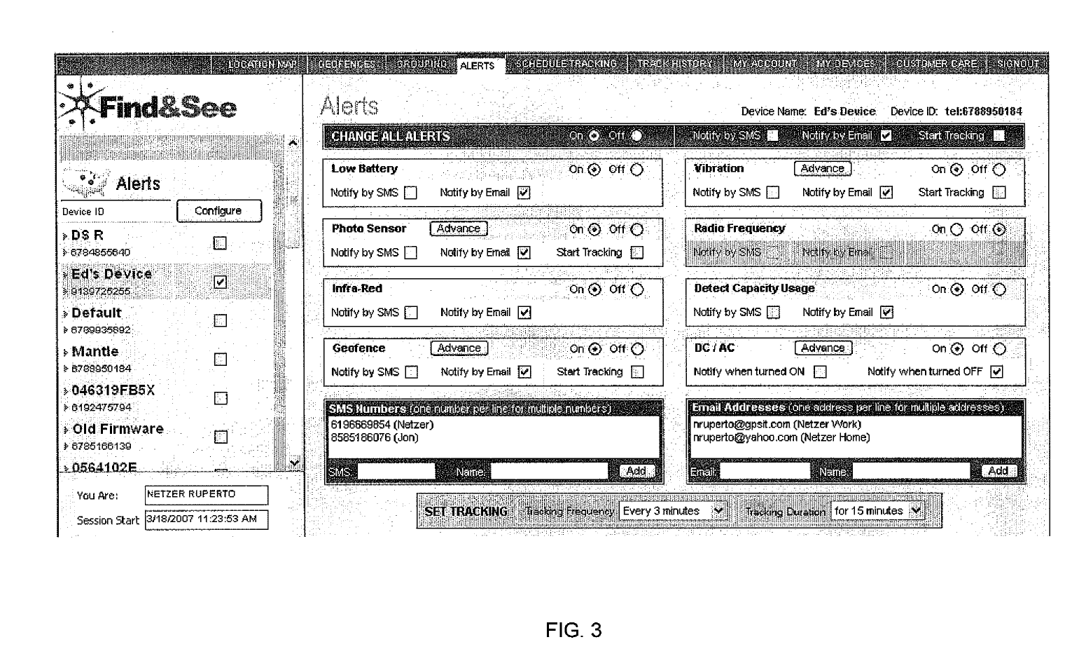

The location and tracking application also includes a navigation tool for navigation to a selected location with a portable device, and as shown in exemplary screen shot of FIG. 3, an alert tool by which a device can generate and transmit an alert if assistance is needed. The alert can be implemented as a “panic button,” and can include a location. The location and tracking application can also display whether any device has audio, video and/or picture in or out capabilities. The location and tracking application or another device can send information, such as an audio communication, to the location associated with a selected or designated device. Alerts can be generated based on battery level, type of capabilities of the device, usage capacity of the device, and whether the device is inside or outside of an established geo-fence, which is explained in further detail below.

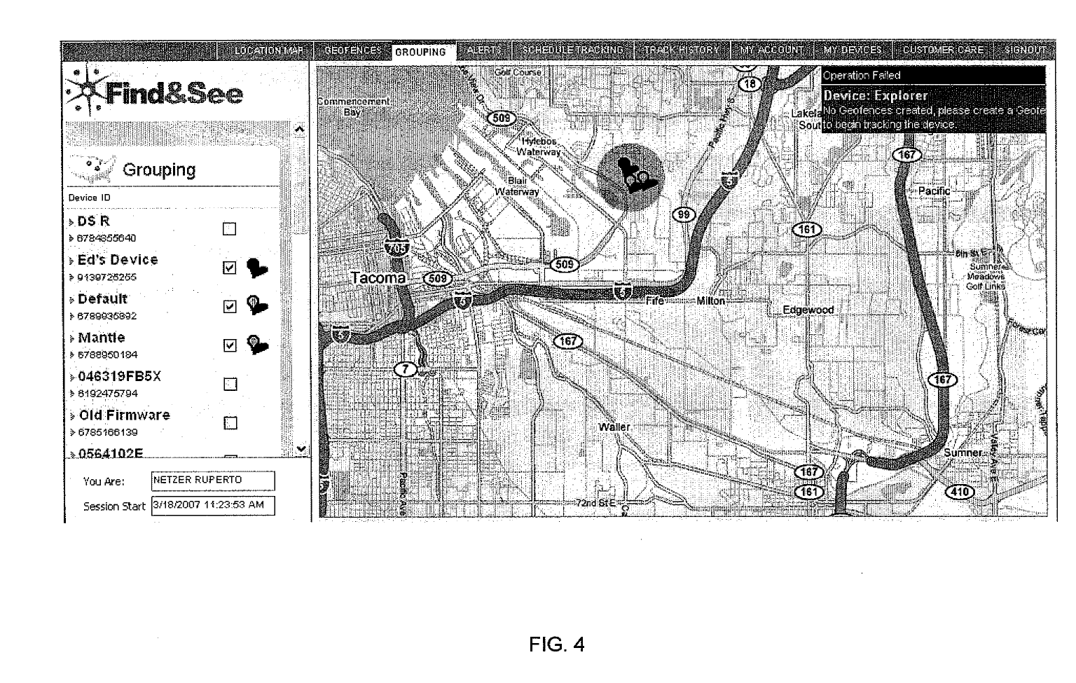

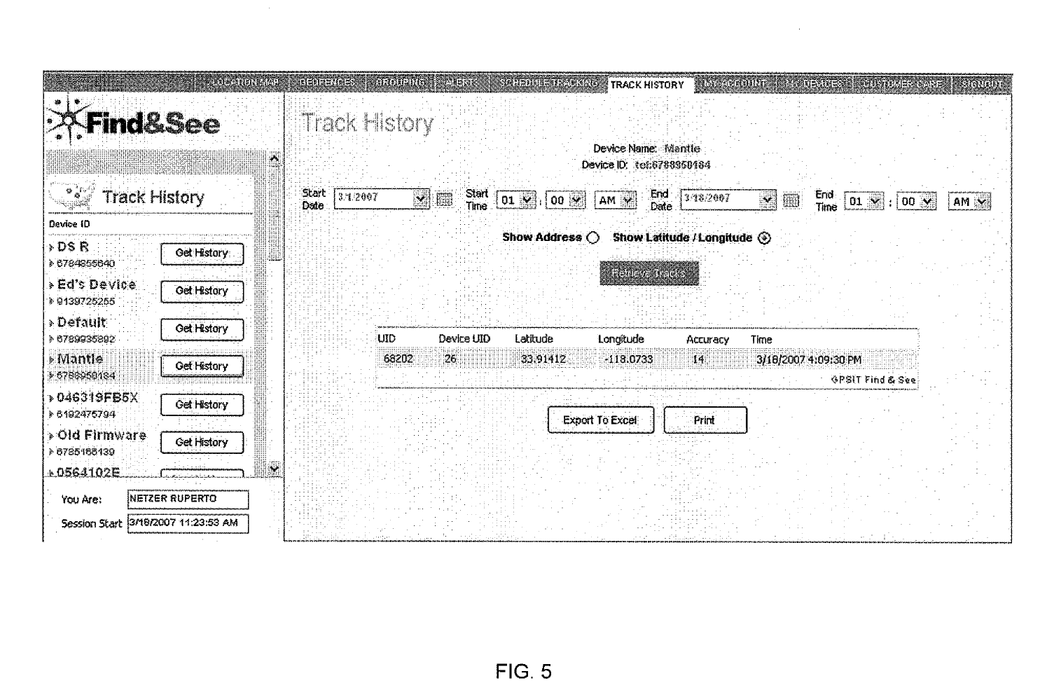

Each of the one or more devices can be located and tracked by being grouped using a grouping tool of the location and tracking application, as shown in the exemplary screen shot of FIG. 4. Each of the one or more devices may also be tracked by the location and tracking application, in a “bread crumb” manner. The tracking can be set for any time in the present or in the future, and can be set from a portable device. FIG. 5 shows an exemplary screen shot of the location and tracking application and the types of historical information and data that can be tracked for each device or group of devices. The historical tracking information can be exported to another application, or printed for hardcopy persistence.

In a particular implementation, the LTS, via the location and tracking application, enables a precise location of a primary device or devices to be ascertained from a secondary device. As such, the location and tracking application can assist in the location of the primary device or devices using the secondary device. The secondary device can send coded signals to the location and tracking application via one or more primary devices, which can then ask the secondary device to send a high frequency sound for detection by a “finder” device. The “finder” device can use directional antenna and a GPS or A-GPS reference for interpolation of the primary device. In one example, if both devices are in the same building, the signal and GPS or A-GPS location of the primary device and “finder” device can be used.

The location and tracking application further enables the secondary device to generate a status, such as a signal strength of the “finder,” to determine if the devices are actually in the same general location. The status may also include a status for the battery, temperature, and a distance away from the “finder.” The location and tracking application can also turn on a signal to multiple secondary devices, and if there are multiple devices with secondary transmitters, the “finder” can find them.

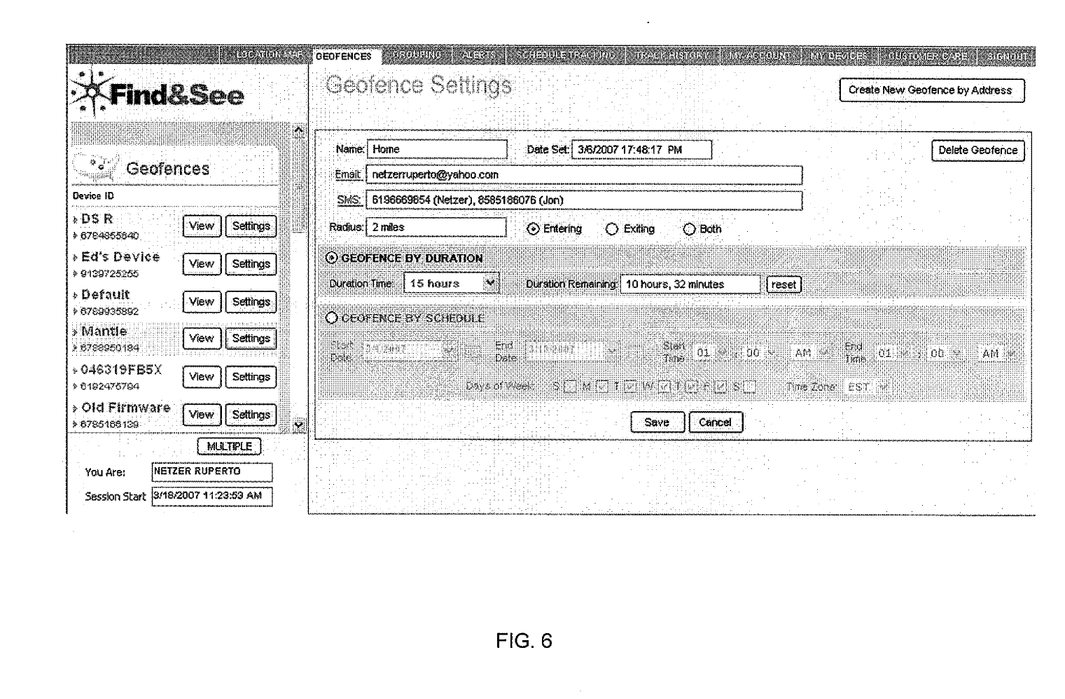

The location and tracking application includes a Geofence tool to manage the devices. If one or more devices leave a defined area, a mobile grouping “Geofence” can then be activated with the group that left the area. As shown in the exemplary screen shot of FIG. 6, devices or devices can be routed by the location and tracking application. Each route can be a pre-assigned road route, for example. If a device goes outside the pre-assigned route, an alert is generated and sent. Each route can also be set by a historical pattern. If a device or devices go to a certain location, the location and tracking application can trace the route. The traced route can be set to avoid hazardous areas or arduous paths.

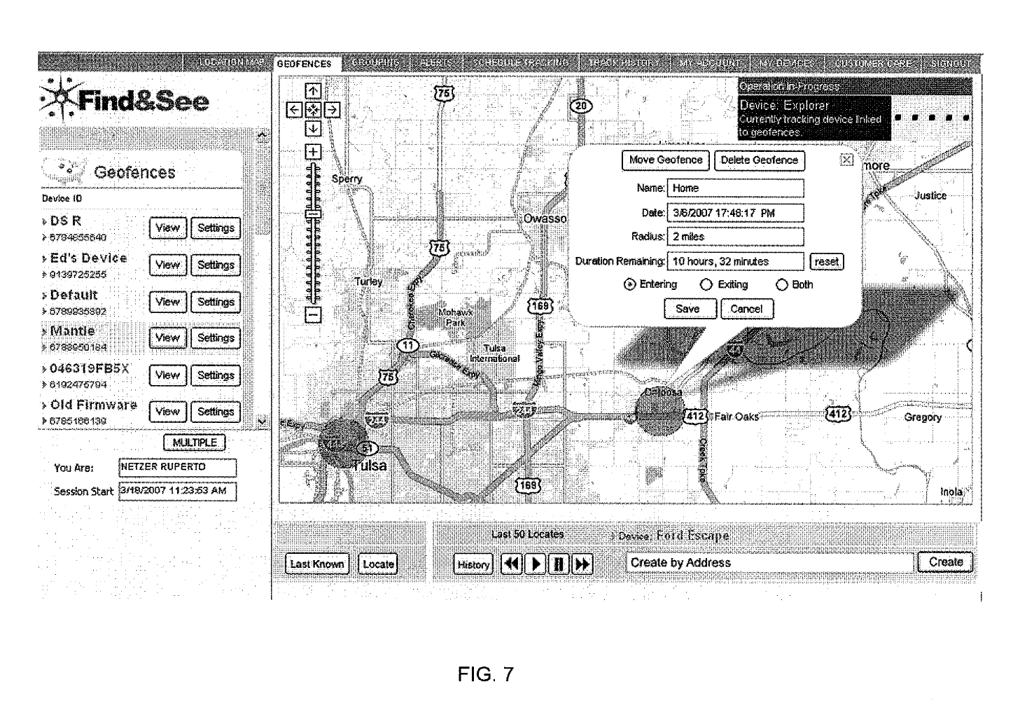

A device or devices can be set to be inside or outside a Geofence, or for entering or leaving a Geofence. In the latter cases, if a device enters or leaves a defined Geofence, then the location and tracking application generates an alert. The Geofence can be defined for any sized area, and can be associated with predefined boundaries that define geography such as a state or a country. A Geofence can also be configured to account for hazardous areas, such as nuclear power plants. In one implementation, devices can be grouped in a route, i.e. a “Mobile Grouping Geofence,” and if one or more devices are separated from the group or stray beyond the route, an alarm is generated. FIG. 7 is an exemplary screen shot of the Geofence tool being used with a map tool to define and employ one or more Geofences.

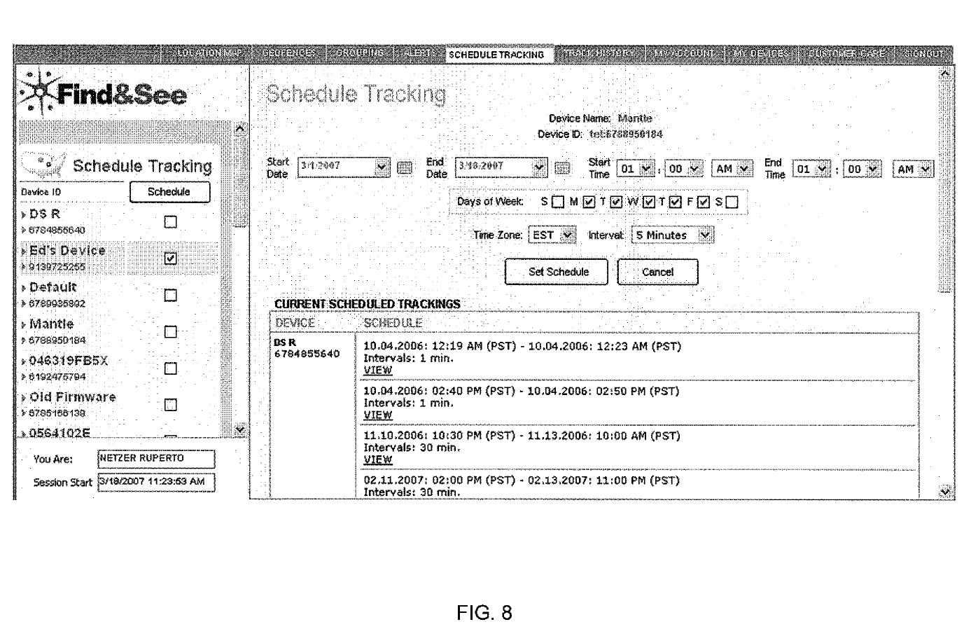

The location and tracking application also includes a history reporting feature having reports of location and tracking sessions. For session reporting, the location and tracking application reports sessions taking place within a range of dates or times. For time reporting, the location and tracking application reports activity within a range of dates or times. Playback of a time reporting report can be played backwards or forwards. Reports can be printed as integrated with maps and/or addresses or coordinates. FIG. 8 is a screen shot illustrating schedule tracking.

For Status Reporting, the location and tracking application can request a device's or group of devices' status, including but not limited to battery, signal coverage, temperature, and status of a secondary device. The location and tracking application includes a battery management feature for sleep mode, which allows the device or devices to manage battery life. The location and tracking application can set a command to wake up at a particular time and send a location, and can go to hibernate or sleep on a set schedule.

The location and tracking application sets notifications or alerts to a client for Geofence, status, locations, or tracking with SMS or notification functionality. The notifications or alerts can be sent to a phone, email or fax. Alerts can be set on the location and tracking application for receiving any kind of state or status, such as a low battery experienced by a device. Other examples include a temperature that exceeds or drops below a predefined threshold, and whether coverage is qualitatively or quantitatively good or bad. Alerts can also be generated based on a schedule. For instance, between 0800-1600 hours, alerts can be set to notify one client, and from 1601 to 0759 to notify another client. Alerts can also be generated based on a date. In an example, an alert can be sent to one party if it occurs between one set of dates, and to another party if it occurs between a second set of dates.

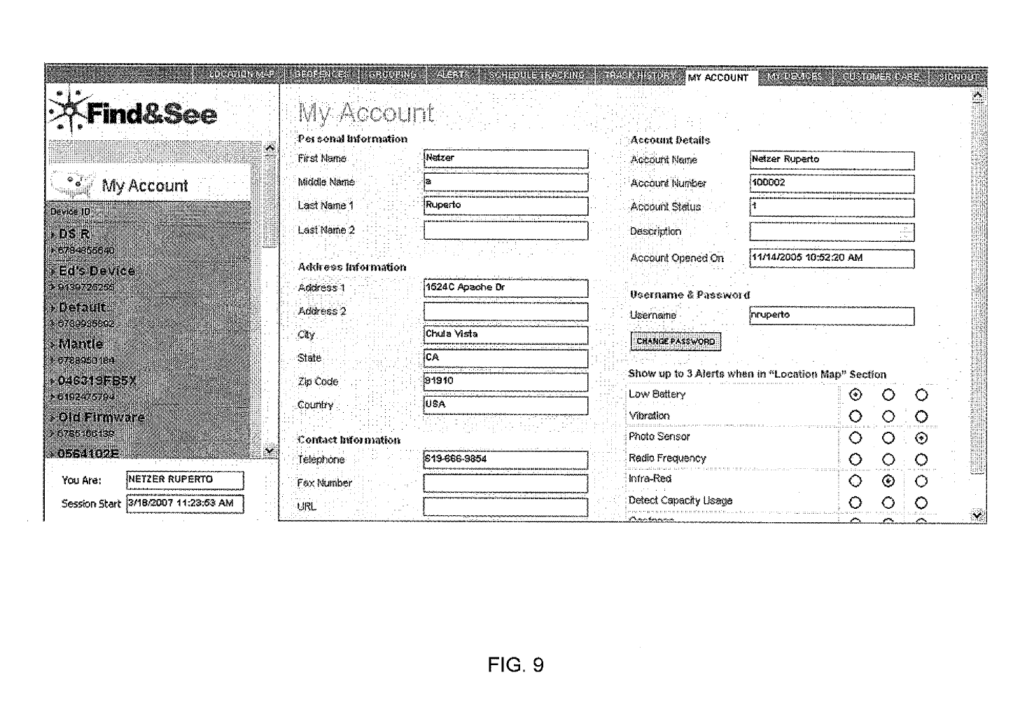

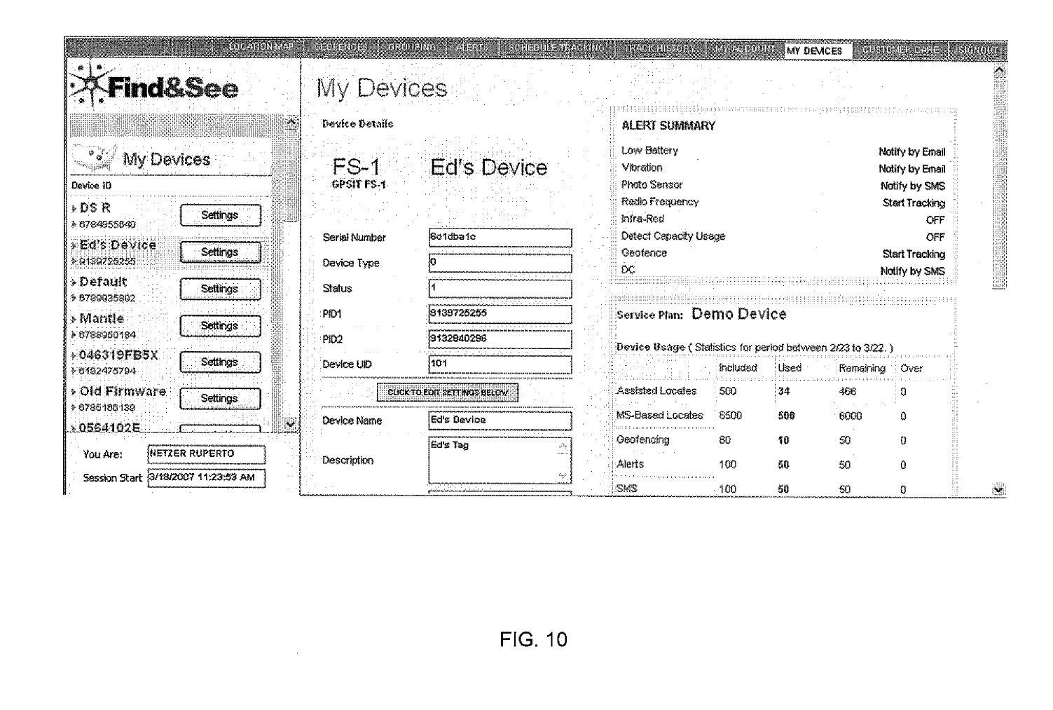

The location and tracking application further includes, or is in communication with, a Master Control System (MCS) that is used to create and manage accounts as well as to program devices. For adding and managing accounts, the MCS tracks customers and distributors related to each account. For adding devices, the MCS executes provisioning and programming, and sets devices to a subscription plan. The MCS can further add OEM distributors, which might provide a different URL for “find” functions. Via the MCS, customers billing accounts can be viewed. The MCS also performs troubleshooting, and includes one or more diagnostic tools for identifying and fixing problems, and for tracking solutions to those problems. FIGS. 9 and 10 are exemplary screen shots showing an account management page and a device management page, respectively.

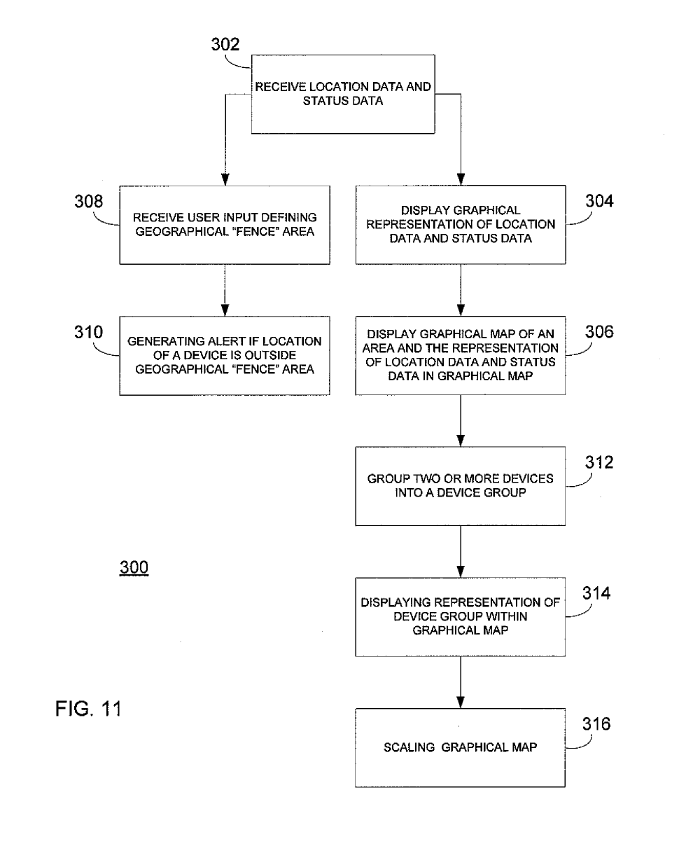

FIG. 11 is a flowchart of a location and tracking method 300 for locating and tracking devices that are mobile. At 302, location data and status data are received. The location data can be GPS or A-GPS location data, and the status data can be any data related to a status of any of the devices. At 304, a server system generates information that can displayed in a representation of the location data and status data. At 306, a graphical map of an area is displayed in a location and tracking application connected with the server system and displayed in a browser of a client computer. The graphical map further includes the representation of the location data and the status data of the devices.

At 308, which can occur coincidentally with other functional steps, user input defining a geographical “fence” area, or Geofence, is received by the server system. The server system in turn provides the Geofence rendering to the client application for display as a graphical map. At 310, an alert is generated if an actual location, as determined by the location data, is outside the Geofence.

At 312, a user of the location and tracking application can group two or more of the devices into a device group. The grouping can be organized in any number of ways, i.e. based on device, travel route, business group, age group, time period, etc. At 314, a representation of the device group is displayed within the graphical map, which, at 316 is automatically and dynamically scaled so as to be able to display each of the devices in the device group at the same time in one graphical user interface.

Some or all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, recited steps of processes or methods can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

What is claimed:

1. A locator and tracking system for managing one or more devices that are mobile, the system comprising:
a server system that receives location data and status data of the one or more devices through one or more communications networks; and
a location and tracking application that is executable on a client computer in a browser window, the location and tracking application displaying a graphical representation of the location data and status data on the client computer.

2. The system in accordance with claim 1, wherein the location and tracking application includes a Geofence tool adapted to receive user input defining a geographical virtual fence area, and based on the location data, to generate an alert if a location according to the location data is outside of the geographical virtual fence area.

3. The system in accordance with claim 1, wherein the location data is provided by the GPS or A-GPS network.

4. The system in accordance with claim 1, wherein the status data includes power status of an associated device.

5. The system in accordance with claim 1, wherein the status data includes a communication modes of an associated device.

6. The system in accordance with claim 1, wherein the location and tracking application is adapted to display a graphical map of an area and a representation of at least one of the one or more devices within the graphical map of the area.

7. The system in accordance with claim 6, wherein the location and tracking application is further adapted to group two or more of the one or more devices into a device group, and display a representation of each of the two or more devices in the device group within the graphical map of the area.

8. The system in accordance with claim 7, wherein the location and tracking application is adapted to scale the graphical map of the area to include all of the two or more devices in the device group within the graphical map.

9. A computer implemented method for locating and tracking one or more devices, the method comprising:
receiving location data and status data of the one or more devices through one or more communications networks; and
displaying a graphical representation of the location data and status data on a client computer executing a location and tracking application in a browser window.

10. The method in accordance with claim 9, further comprising:
receiving by the location and tracking application user input defining a geographical virtual fence area; and
based on the location data, generating an alert if a location according to the location data is outside of the geographical virtual fence area.

11. The method in accordance with claim 9, wherein the location data is provided by the GPS or A-GPS network.

12. The method in accordance with claim 9, wherein the status data includes power status of an associated device.

13. The method in accordance with claim 9, wherein the status data includes a communication modes of an associated device.

14. The method in accordance with claim 9, further comprising displaying, in the browser window, a graphical map of an area and a representation of at least one of the one or more devices within the graphical map of the area.

15. The method in accordance with claim 14, further comprising:
grouping two or more of the one or more devices into a device group; and
displaying a representation of each of the two or more devices in the device group within the graphical map of the area.

16. The method in accordance with claim 15, further comprising scaling the graphical map of the area to include all of the two or more devices in the device group within the graphical map.
